(19) United States
(12) Patent Application Publication
(10) Pub. No.: US 2023/0065537 A1
(43) Pub. Date: Mar. 2, 2023

(54) EMBEDDED EYE TRACKER USING PUPIL EXPANDER GLARE PRISM

(71) Applicant: GM Global Technology Operations LLC, Detroit, MI (US)

(72) Inventors: Thomas A. Seder, Fraser, MI (US); Kai-Han Chang, Madison Heights, MI (US)

(21) Appl. No.: 17/460,634

(22) Filed: Aug. 30, 2021

(51) Int. Cl. G02B 27/01; G02B 27/00; G02B 5/04; G02B 5/28

(52) U.S. Cl. CPC G02B 27/0101; G02B 27/0093; G02B 5/04; G02B 5/282; G02B 2027/0109; G02B 2027/0138

(57) ABSTRACT

A head-up display and a system and method of operating a head-up display. The head-up display includes a prism, an imager and a camera. The prism has a first surface and a second surface. An infrared-reflective coating on the second surface of the prism has a maximum reflectivity at a selected wavelength. The imager is configured to project a hologram into the prism via the first surface, out of the prism via the second surface, through the infrared-reflective coating and into an eyebox. The camera is configured to receive an eye tracking beam from the eyebox that is reflected from the infrared-reflective coating. A processor determines eye information from the eye tracking beam and adjusts a parameter of the hologram based on the eye information.

### INTRODUCTION

The subject disclosure relates to head-up displays and, in particular, to a head-up display that is integrated with an eye tracking system.

A vehicle can include a head-up display that projects an image onto a windshield of the vehicle to allow the driver to view the image without taking his eyes off of the road. A vehicle can also include an eye tracker that monitors an eye of the driver to determine his level of alertness, direction of awareness, etc. Often the eye tracking information obtained from the eye tracker can be used by the head-up display to determine where to place an image for the driver. However, there are difficulties that arise by having a head up display and eye tracker as separate entities. For example, there is latency involved in transferring data from the eye tracker to the head-up display. Also, alignment issues arise due to differences in positions of the head-up display and eye tracker. Accordingly, it is desirable to have a head-up display that includes eye tracking capabilities.

### SUMMARY

In one exemplary embodiment, a head-up display is disclosed. The head-up display includes a prism, an imager and a camera. The prism has a first surface and a second surface. An infrared-reflective coating on the second surface of the prism has a maximum reflectivity at a selected wavelength. The imager is configured to project a hologram into the prism via the first surface, out of the prism via the second surface, through the infrared-reflective coating and into an eyebox. The camera is configured to receive an eye tracking beam from the eyebox that is reflected from the infrared-reflective coating.

In addition to one or more of the features described herein, the selected wavelength is in a range from about 780 nm to about 1000 nanometers. The head-up display further includes an illuminator configured to project a source beam at the selected wavelength into the eyebox via reflection from the infrared-reflective coating. The eye tracking beam is a reflection of the source beam at the eyebox. The head-up further includes a signal amplifier for synchronizing the illuminator with the camera. The head-up display further includes a processor for determining eye information based on the eye tracking beam and sends a signal to the imager to adjust the hologram based on the eye information. In an embodiment, the infrared-reflective coating is made of a multi-layer dielectric material.

In another exemplary embodiment, a system for operating a head-up display is disclosed. The system includes a prism, an imager, a camera and a processor. The prism has a first surface and a second surface. An infrared-reflective coating on the second surface of the prism has a maximum reflectivity at a selected wavelength. The imager is configured to project a hologram into the prism via the first surface, out of the prism via the second surface, through the infrared-reflective coating and into an eyebox. The camera is configured to receive an eye tracking beam from the eyebox that is reflected from the infrared-reflective coating. The processor determines eye information from the eye tracking beam and adjusts a parameter of the hologram based on the eye information.

In addition to one or more of the features described herein, the selected wavelength is in a range from about 780 nm to about 1000 nanometers. The system further includes an illuminator configured to project a source beam at the selected wavelength into the eyebox via reflection from the infrared-reflective coating. The selected wavelength is within a reflectivity band of the infrared-reflective coating and a central wavelength of the source beam and the central wavelength of the eye tracking beam is within the band. The system further includes a signal amplifier for synchronizing the illuminator with the camera. The processor is configured to determine eye information from the eye tracking beam and send a signal to the imager to adjust the hologram based on the eye information. In an embodiment, the infrared-reflective coating is made of a multi-layer dielectric material.

In yet another exemplary embodiment, a method of operating a head-up display is disclosed. A hologram is projected into an eyebox via a prism having a first surface and a second surface and an infrared-reflective coating on the second surface of the prism, the infrared-reflective coating having a maximum reflectivity at a selected wavelength. An eye tracking beam is received from the eyebox at a camera, wherein the eye tracking beam is reflected from the infrared-reflective coating. Eye information is determined from the eye tracking beam. The hologram is adjusted based on the eye information.

In addition to one or more of the features described herein, the selected wavelength is in a range from about 780 nm to about 1000 nanometers. The method further includes projecting a source beam from an illuminator into the eyebox via reflection from the infrared-reflective coating. The selected wavelength is within a reflectivity band of the infrared-reflective coating and a central wavelength of the source beam and the central wavelength of the eye tracking beam is within the band. The method further includes synchronizing the illuminator with the camera using a signal amplifier. In an embodiment, the infrared-reflective coating is made of a multi-layer dielectric material.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an interior view of a vehicle; and

FIG. 2 shows a detailed view of a head-up display system in an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

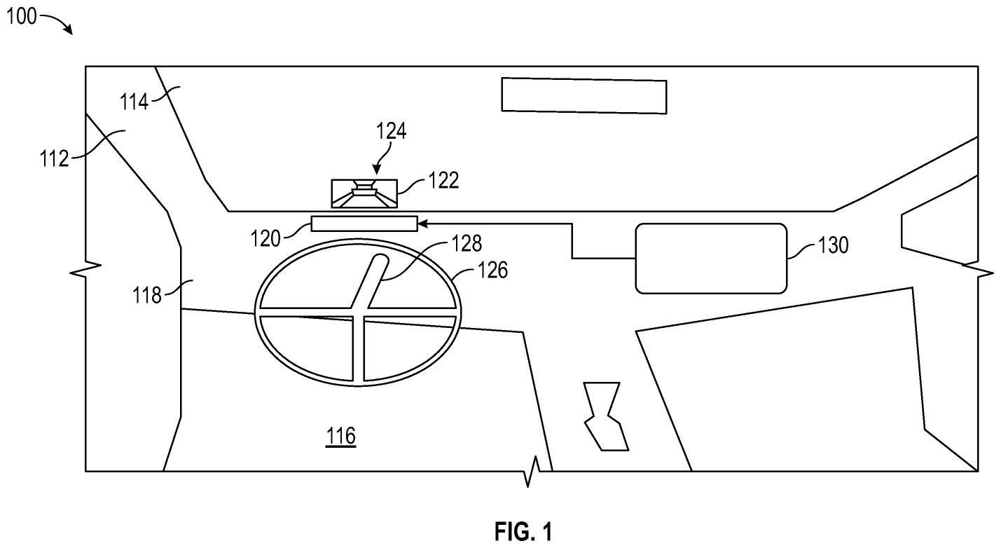

In accordance with an exemplary embodiment, FIG. 1 shows an interior view of a vehicle 100. The vehicle 100 includes a body structure 112 and a windshield 114 that enclose a cabin 116 of the vehicle 100. A steering wheel 126 and a steering column 128 are disposed within the cabin 116. In addition, the vehicle 100 includes a dashboard 118 mounted to the body structure 112. A head-up display system (HUD system 120) can be mounted at a surface within the cabin 116, such as the dashboard 118, for example. The HUD system 120 projects an image 122 onto an area 124 of the windshield 114. As discussed herein, the HUD system 120 includes the ability to track an eye of the driver as well as to display information at the windshield 114 for viewing by the driver.

A system control module 130 controls the HUD system 120 to project the image 122 into the area 124. The image 122 can be a holographic image and may include text, symbols, and/or gauges. The system control module 130 may control the content of the image to be projected by the HUD system 120 and/or the location and distortion of the image to be projected by the HUD system 120. The system control module 130 further controls operation of an eye tracking system to determine eye tracking information from light received at the HUD system 120.

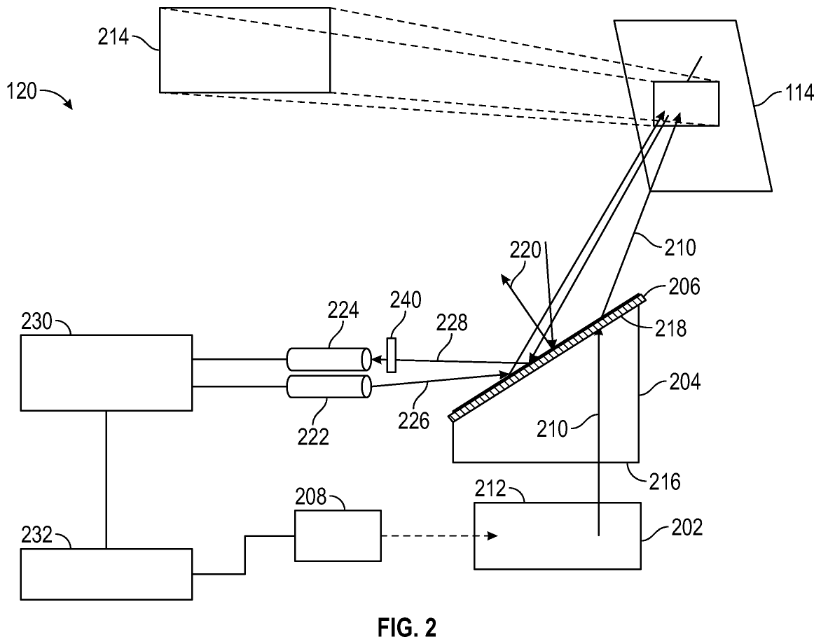

FIG. 2 shows a detailed view of the HUD system 120 in an embodiment. The HUD system 120 includes a first set of optical elements for implementing a head-up display, such as a holographic waveguide 202 and a prism 204 having an infrared-reflective coating (IR coating 206) formed thereon. The HUD system 120 also includes a second set of optical elements for implementing an eye tracker, such as an illuminator 222, a camera 224 and a signal amplifier 230. The illuminator 222 and the camera 224 use the prism 204 and IR coating 206 for operation of the eye tracker, as discussed herein.

Referring first to the first set of optical elements, the holographic waveguide 202 serves as a pupil replicator. The holographic waveguide 202 can be a single array waveguide. In another embodiment, the holographic waveguide 202 may be configured to project a two-dimensional array of holograms into an eyebox 214. The holographic waveguide 202 may be implemented as a slab of optic glass.

The prism 204 includes a lower surface 216 (i.e., a first surface) and an upper surface 218 (i.e., a second surface). The lower surface 216 is parallel to the output face 212 of the holographic waveguide 202, and the upper surface 218 is not parallel to the output face 212. The IR coating 206 is formed on the upper surface 218. The IR coating 206 is a thin film. In various embodiments, the IR coating is a broadband reflector having a maximum reflectivity at a selected wavelength. In various embodiments, the selected wavelength is 940 nanometers (nm). In other embodiments, the selected wavelength is in a range from about 780 nm to about 1000 nm. The selected wavelength and is within a reflectivity band of the IR coating 206, which can be in the range from 780 nm to 1000 nm, in various embodiments. Additionally, this wavelength is not meant as a limitation of the invention. The IR coating 206 can be made of a multi-layer dielectric material. Alternatively, the IR coating 206 is a holographic optical element.

An imager 208 projects a hologram 210 into the holographic waveguide 202. A central wavelength of the hologram 210 is within a visible light range. The hologram 210 exits the holographic waveguide 202 through output face 212. The hologram 210 then passes into the prism 204 via the lower surface 216, out of the prism 204 via the upper surface 218 and IR coating 206, and onto the windshield 114. The hologram 210 is visible to the viewer when his eye is within an eyebox 214.

Ambient light 220 (e.g., sunlight, exterior or interior lighting, etc.) can be incident on the upper surface 218 of the prism 204. The upper surface 218 is oriented to direct the ambient light 220 in a direction that is outside of the eyebox 214, thereby preventing glare. Meanwhile, the hologram 210 output from the holographic waveguide 202 is still projected into the eyebox 214.

Referring now to the second set of optical elements, the illuminator 222 and the camera 224 are coupled to signal amplifier 230. The signal amplifier 230 synchronizes the illuminator 222 with the camera 224. In an embodiment, the illuminator 222 is a modulated infrared light emitting diode (IR LED) array. The illuminator 222 generates a source beam 226 having a source wavelength that matches the selected wavelength of the IR coating 206. A bandpass filter 240 is placed in front of the camera 224. The bandpass filter 240 is an infrared notch filter that allows infrared light at the selected wavelength of the IR coating 206 to transmit through while blocking other wavelengths, thus causing the camera 224 to receive light at the selected wavelength. In other embodiments, the band pass filter 240 can be an integrated element of the camera 224. The signal amplifier 230 operates the illuminator 222 and the camera 224 using pulse-width modulation to achieve an optimal or substantially optimal signal-to-noise ratio for an eye tracking beam 228 received at the camera 224.

The illuminator 222 projects the source beam 226 at the upper surface 218 of the prism 204. The source beam 226 reflects from the IR coating 206 and into the eyebox 214, where it is reflected from the viewer's eye to generate the eye tracking beam 228 that includes information concerning the viewer's eye location, eye orientation, etc. The eye tracking beam 228 is directed from the eyebox 214 to the prism 204 and reflects off of the IR coating 206 on the upper surface 218 of the prism 204 and into the camera 224.

Eye tracking data obtained based on the eye tracking beam 228 is sent from the signal amplifier 230 to a processor 232. The processor 232 determines eye information from the eye tracking data, such as the location of the eye, the orientation of the eye, etc. The processor 232 can then determine an adjustment to a parameter of the hologram 210 that changes or affects an appearance of the hologram 210 within the eyebox 214. For example, the parameter can be adjusted to change a placement of the hologram 210 within the eyebox 214 to capture the viewer's attention. The processor 232 then sends a control signal to the imager 208 to control or adjust the parameter of the hologram 210.

By reflecting the source beam 226 and eye tracking beam 228 from the IR coating 206, these beams share or substantially share the same optical path as does the hologram 210, at least between the prism 204 and the eyebox 214. Thus, the eye tracking information obtained using the eye tracking beam 228 is aligned with the hologram 210, thereby reducing the amount of alignment correction this is needed. Additionally, the latency involved with adjusting the head-up display based on eye information is reduced, in comparison to a separate head-up display and eye tracking system.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A head-up display for a vehicle, comprising:
a prism having a first surface and a second surface;
an infrared-reflective coating on the second surface of the prism, the infrared-reflective coating having a maximum reflectivity at a selected wavelength;
an imager configured to project a hologram into the prism via the first surface, out of the prism via the second surface, through the infrared-reflective coating to reflect off of a windshield of the vehicle and into an eyebox; and
a camera configured to receive an eye tracking beam from the eyebox that is reflected from the windshield and the infrared-reflective coating.

2. The head-up display of claim 1, wherein the selected wavelength is in a range from about 780 nm to about 1000 nanometers.

3. The head-up display of claim 1, further comprising an illuminator configured to project a source beam at the selected wavelength into the eyebox via reflection from the infrared-reflective coating and the windshield.

4. The head-up display of claim 3, wherein the eye tracking beam is a reflection of the source beam at the eyebox.

5. The head-up display of claim 3, further comprising a signal amplifier for synchronizing the illuminator with the camera.

6. The head-up display of claim 5, further comprising a processor for determining eye information based on the eye tracking beam and sends a signal to the imager to adjust the hologram based on the eye information.

7. The head-up display of claim 1, wherein the infrared-reflective coating is made of a multi-layer dielectric material.

8. A system for operating a head-up display of a vehicle, comprising:
a prism having a first surface and a second surface;
an infrared-reflective coating on the second surface of the prism, the infrared-reflective coating having a maximum reflectivity at a selected wavelength;
an imager configured to project a hologram into the prism via the first surface, out of the prism via the second surface, through the infrared-reflective coating to reflect off of a windshield of the vehicle and into an eyebox;
a camera configured to receive an eye tracking beam from the eyebox that is reflected from the windshield and the infrared-reflective coating; and
a processor for determining eye information from the eye tracking beam and adjusting a parameter of the hologram based on the eye information.

9. The system of claim 8, wherein the selected wavelength is in a range from about 780 nm to about 1000 nanometers.

10. The system of claim 8, further comprising an illuminator configured to project a source beam at the selected wavelength into the eyebox via reflection from the infrared-reflective coating and the windshield.

11. The system of claim 10, wherein the selected wavelength is within a reflectivity band of the infrared-reflective coating and a central wavelength of the source beam and the central wavelength of the eye tracking beam is within the band.

12. The system of claim 10, further comprising a signal amplifier for synchronizing the illuminator with the camera.

13. The system of claim 8, wherein the processor is configured to determine eye information from the eye tracking beam and send a signal to the imager to adjust the hologram based on the eye information.

14. The system of claim 8, wherein the infrared-reflective coating is made of a multi-layer dielectric material.

15. A method of operating a head-up display of a vehicle, comprising:
projecting a hologram into an eyebox via a prism and a windshield of the vehicle, the prism having a first surface and a second surface and an infrared-reflective coating on the second surface of the prism, the infrared-reflective coating having a maximum reflectivity at a selected wavelength;
receiving an eye tracking beam from the eyebox at a camera, wherein the eye tracking beam is reflected from the windshield and the infrared-reflective coating;
determining eye information from the eye tracking beam; and
adjusting the hologram based on the eye information.

16. The method of claim 15, wherein the selected wavelength is in a range from about 780 nm to about 1000 nanometers.

17. The method of claim 15, further comprising projecting a source beam from an illuminator into the eyebox via reflection from the infrared-reflective coating and the windshield.

18. The method of claim 17, wherein the selected wavelength is within a reflectivity band of the infrared-reflective coating and a central wavelength of the source beam and the central wavelength of the eye tracking beam is within the band.

19. The method of claim 18, further comprising synchronizing the illuminator with the camera using a signal amplifier.

20. The method of claim 15, wherein the infrared-reflective coating is made of a multi-layer dielectric material.
